(19) United States
(12) Patent Application Publication
(10) Pub. No.: US 2017/0006249 A1
(43) Pub. Date: Jan. 5, 2017

(54) SYSTEMS AND METHODS PROVIDING INTERFERENCE CANCELLATION FOR RECEIVING STATIONS EXPERIENCING HIGH INTERFERENCE

(71) Applicant: QUALCOMM Incorporated, San Diego, CA (US)

(72) Inventors: Gordon Kent Walker, Poway, CA (US); Guillaume Philippe Lebrun, Muenchen (DE); Ernest Tadashi Ozaki, Poway, CA (US); Mohsen Farmahini Farahani, San Diego, CA (US)

(21) Appl. No.: 15/176,914

(22) Filed: Jun. 8, 2016

Related U.S. Application Data
(60) Provisional application No. 62/188,050, filed on Jul. 2, 2015.

(51) Int. Cl. H04N 5/50; H01Q 1/52; H01Q 25/00; H01Q 5/49; H01Q 1/36

(52) U.S. Cl. CPC H04N 5/50; H01Q 5/49; H01Q 1/36; H01Q 25/005; H01Q 1/521

(57) ABSTRACT

Systems and methods which provide enhanced isolation for receivers using relatively simple and inexpensive modifications or additional circuitry at a receiving station. Embodiments augment a primary antenna of a receiving station with a correlated heterogeneous antenna element. Augmented antenna systems of embodiments provide an appreciable increase in front-to-back isolation with respect to desired signals received at a receiving station. Such augmented antenna systems are particularly useful in a high interference environment, such as an interference limited environment as may be experienced at the edge of two Single Frequency Networks (SFNs). For example, embodiments of an augmented antenna system may be utilized in situations in which positive carrier to noise ratio (C/N) conditions are present (e.g., more signal than noise is present in the desired signal and more signal than noise is present in the interfering signal).

### REFERENCE TO RELATED APPLICATIONS

The present application claims priority to U.S. provisional application Ser. No. 62/188,050 entitled “SYSTEMS AND METHODS PROVIDING INTERFERENCE CANCELLATION FOR RECEIVING STATIONS EXPERIENCING HIGH INTERFERENCE” filed Jul. 2, 2015, the disclosures of which are hereby expressly incorporated by reference herein.

### FIELD

This disclosure relates generally to wireless communications and, more particularly, to providing interference cancellation for receiving stations experiencing high interference, such as interference limited receiving stations.

### BACKGROUND

Terrestrial broadcast of television (TV) signals to provide wireless delivery of various content (e.g., shows, sporting events, news programming, etc.) to users, both in urban and rural areas, has been widely implemented throughout the world for many years. Such broadcasts have historically utilized analog signals modulated within relatively broad (e.g., 6 MHz in the United States and 8 MHz in Europe) channels broadcast using high tower, high power transmitters. Such broadcast networks in general transmit to a roof top (at least at the edges of coverage areas) horizontally polarized antenna (although receive stations deployed in interior portions of the coverage area may use indoor antennas). Channel frequency reuse patterns of 1 of 3 or 1 of 4 (e.g., areas in which a particular channel frequency are reused are separated by at least 3 or 4 areas of different channel frequencies) to avoid or mitigate interference associated with such channel reuse. Such historic broadcast TV deployment was not spectrally efficient and has resulted in the inability to fully satisfy the demand for wireless services, particularly in urban and suburban areas.

Digital television (DTV) standards have been developed more recently which provide for improved spectral efficiency. For example, although utilizing the legacy broadcast channel frequency bands, the digital signals of DTV have enabled broadcast of multiple separate content streams within each frequency channel (e.g., through the use of multiplexing of physical radio frequency (RF) channels to carry several digital subchannels). Having grown out of the historic analog TV broadcast paradigm, DTV broadcast has been predicated on high tower, high power transmitters, and thus utilizing spectrally inefficient channel frequency reuse patterns (e.g., the aforementioned 1 of 3 or 1 of 4).

There has been interest in converting such broadcast networks to operate from low power, low tower transmitters, such as using the evolved Multimedia Broadcast Multicast Service (eMBMS) point-to-multipoint transmission scheme or similar techniques. Such a transmission system is operated as Single Frequency Network (SFN), whereby a plurality of transmission stations operating using the same frequencies may be deployed relatively near one another (e.g., 10-20 km Inter Site Distance (ISD)) to serve an aggregate service area. Such a low tower, low power network may operate with 100% spectral reuse, if there is sufficient isolation between adjacent SFNs to support the desired Signal to Interference plus Noise Ratio (SINR). The isolation achieved via the front-to-back ratio of pre-existing roof top antennas conforming to the ITU-R BT419-3 guidelines is approximately 16 dB. Such isolation may be insufficient to provide satisfactory reception, such as at edge locations of two adjacent SFNs (e.g., where signals transmitted by an adjacent SFN is essentially jamming a receiving station of the neighboring SFN).

### SUMMARY

According to an embodiment, a method for increased receive signal front-to-back isolation in a wireless communication system is provided. The method of embodiments includes disposing a secondary antenna element in an antenna system to thereby provide an augmented antenna system, the antenna system including a primary antenna, wherein the secondary antenna element is a correlated heterogeneous antenna element with respect to the primary antenna. The method of embodiments also includes coupling the secondary antenna element to a port of a signal processing circuit having at least one of a Minimum Mean Square Error (MMSE) processing circuit or a Maximum Ratio Combining (MRC) processing circuit, wherein the primary antenna is coupled to a different port of the signal processing circuit. The method of embodiments further includes employing MMSE or MRC combining of a signal provided by the primary antenna and a signal provided by the secondary antenna element by the signal processing circuit to provide interference cancellation for interference present in the signal provided by the primary antenna.

According to a further embodiment, a system for increased receive signal front-to-back isolation in a wireless communication system is provided. The system of embodiments includes an antenna system having a primary antenna and a secondary antenna element, wherein the secondary antenna element is a correlated heterogeneous antenna element with respect to the primary antenna, and wherein the secondary antenna element is disposed in the antenna system to provide an augmented antenna system. The system of embodiments also includes a signal processing circuit having a plurality of signal input ports and having at least one of a Minimum Mean Square Error (MMSE) processing circuit or a Maximum Ratio Combining (MRC) processing circuit, wherein the first antenna element is coupled to a first port of the plurality of signal input ports and the secondary antenna element is coupled to a second port of the plurality of signal input ports, and wherein the signal processing circuit is operable to combine a signal provided by the primary antenna and a signal provided by the secondary antenna element using MMSE or MRC combining to provide interference cancellation for interference present in the signal provided by the primary antenna.

According to a still further embodiment, a system for increased receive signal front-to-back isolation in a wireless communication system. The system of embodiments includes means for disposing a secondary antenna element in an antenna system to thereby provide an augmented antenna system, the antenna system including a primary antenna, wherein the secondary antenna element is a correlated heterogeneous antenna element with respect to the primary antenna. The system of embodiments also includes means for coupling the secondary antenna element to a port of a signal processing circuit having at least one of a Minimum Mean Square Error (MMSE) processing circuit or a Maximum Ratio Combining (MRC) processing circuit, wherein the primary antenna is coupled to a different port of the signal processing circuit. The system of embodiments further includes means for employing MMSE or MRC combining of a signal provided by the primary antenna and a signal provided by the secondary antenna element by the signal processing circuit to provide interference cancellation for interference present in the signal provided by the primary antenna.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiments disclosed may be readily utilized as a basis for modifying or designing other structures for carrying out the same purposes of the present disclosure. It should also be realized by those skilled in the art that such equivalent constructions do not depart from the spirit and scope of the disclosure as set forth in the appended claims. The novel features which are believed to be characteristic of the disclosure, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the disclosed system and methods, reference is now made to the following descriptions taken in conjunction with the accompanying drawings.

FIG. 1 shows an exemplary wireless communication system in which augmented antenna systems of embodiments of the present disclosure may be utilized;

FIG. 2 shows a receiving station adapted to include an augmented antenna system according to embodiments of the present disclosure;

FIG. 3A shows simulation results for two configurations of antennas in a plurality of use cases;

FIG. 3B shows the discrimination provided by an exemplary embodiment of a directional antenna as may be utilized as a primary antenna of an augmented antenna system of embodiments of the present disclosure;

FIG. 3C shows a representative antenna pattern for a directional antenna as may be utilized as a primary antenna of an augmented antenna system of embodiments of the present disclosure;

FIG. 3D shows a representative antenna pattern for an omni-directional antenna as may be utilized as a secondary antenna of an augmented antenna system of embodiments of the present disclosure;

FIG. 3E shows an exemplary 61 site SFN configuration used for simulating operation of configurations of antennas of an augmented antenna system of embodiments of the present disclosure;

FIG. 4A shows the total received power as a function of antenna direction for a directional antenna as may be utilized as a primary antenna according to embodiments of the present disclosure;

FIG. 4B shows the relative power received from a rear interference SFN relative to the forward pointing direction of the directional antenna of FIG. 4A according to embodiments of the present disclosure;

FIG. 4C shows the net SINR for the primary directional antenna of FIG. 4A as a function of pointing direction according to embodiments of the present disclosure;

FIGS. 5A and 5B show a configuration of an augmented antenna system wherein the secondary antenna element may be retrofitted or otherwise added to the antenna system according to embodiments of the present disclosure;

FIGS. 6A and 6B show a configuration of an augmented antenna system wherein the secondary antenna element may be included in the structure of the primary antenna according to embodiments of the present disclosure; and

FIG. 7 shows a high level flow diagram of a method for providing increased receive signal front-to-back isolation in a wireless communication system in accordance with embodiments of the present disclosure.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The word “exemplary” is used herein to mean “serving as an example, instance, or illustration.” Any aspect described herein as “exemplary” is not necessarily to be construed as preferred or advantageous over other aspects.

As used in this description, the term “content” may include data having video, audio, combinations of video and audio, or other data at one or more quality levels, the quality level determined by bit rate, resolution, or other factors. The content may also include executable content, such as: object code, scripts, byte code, markup language files, and patches. In addition, “content” may also include files that are not executable in nature, such as documents that may need to be opened or other data files that need to be accessed.

As used in the description herein, the term “receiving station” refers to a wireless communication system at least configured to receive radio frequency (RF) signals, such as may carry various content to be utilized by one or more device of or coupled to the receiving station. A receiving station of embodiments may additionally provide for transmission of RF signals, and thus a receiving station of embodiments may comprise a transceiver station. A receiving station includes at least one antenna system for facilitating the wireless communication.

As used in this description, the term “streaming content” refers to content that may be sent from a source server device, such as a server, head-end system, etc., and received at a receiving device, such as a user device, terminal equipment, etc., according to one or more standards that enable the transfer of content, whether in real-time or otherwise. Examples of streaming content standards include those that support de-interleaved (or multiple) channels and those that do not support de-interleaved (or multiple) channels.

As used herein, the terms “user equipment,” “user device,” and “client device” include devices capable of receiving content, such as from a server or other source, and may comprise a part of a receiving station herein. Such devices can be stationary devices or mobile devices. The terms “user equipment,” “user device,” and “client device” can be used interchangeably.

As used herein, the term “user” refers to an individual using, accessing, or otherwise associated with the operation of a user device. For example, a user may receive content via a user device or a client device.

Systems and methods disclosed herein provide techniques which enhance the isolation for receivers using relatively simple and inexpensive modifications or additional circuitry at a receiving station. Embodiments implemented according to concepts herein augment a primary antenna of a receiving station with a secondary antenna element. Augmented antenna systems of embodiments provide an appreciable increase in front-to-back isolation with respect to desired signals received at a receiving station, such as on the order of 10 dB. Such augmented antenna systems are particularly useful in a high interference environment, such as an interference limited environment as may be experienced at the edge of two Single Frequency Networks (SFNs), although it should be appreciated there is no restriction on the use of an augmented antenna system herein at the edge of a SFN with interference from a traditional high tower high power network. For example, embodiments of an augmented antenna system may be utilized in situations in which positive carrier to noise ratio (C/N) conditions are present (e.g., more signal than noise is present in the desired signal and more signal than noise is present in the interfering signal).

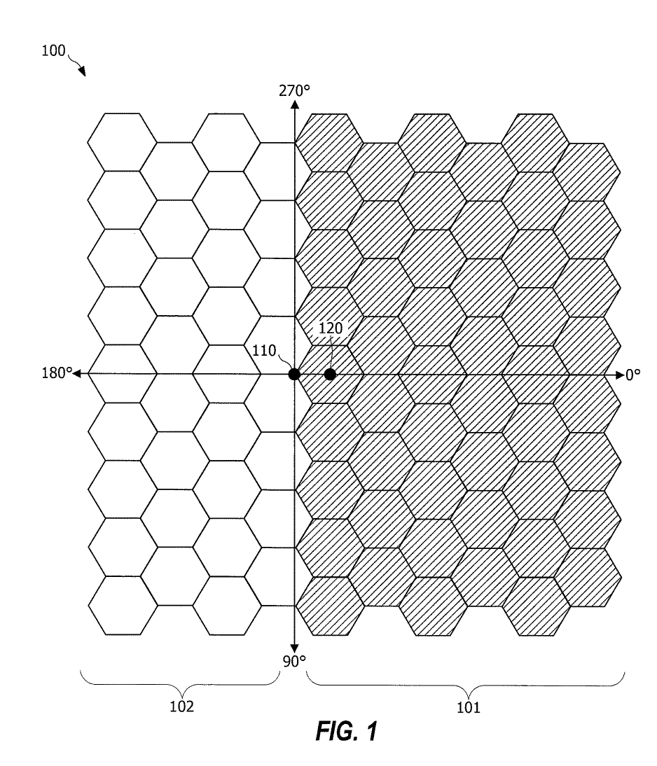

Directing attention to FIG. 1, a portion of exemplary system 100 in which embodiments of the present disclosure may be utilized is shown. In particular, portions of two adjacent SFNs, shown as SFN 101 and SFN 102 are shown, wherein receiving station 110 adapted according to the concepts herein is deployed to implement a wireless link with one or more transmitting stations of SFN 101. For example, each hexagonal area (e.g., cells having a radius of approximately 10 km) of SFNs 101 and 102 may represent a portion of the respective coverage areas served by a transmitting station (one such transmitting station being shown as transmitting station 120), such as may comprise a basestation, a node B, an evolved node B (eNB), a broadcast station, etc., disposed within the coverage area portion (e.g., disposed in the center of the illustrated hexagon).

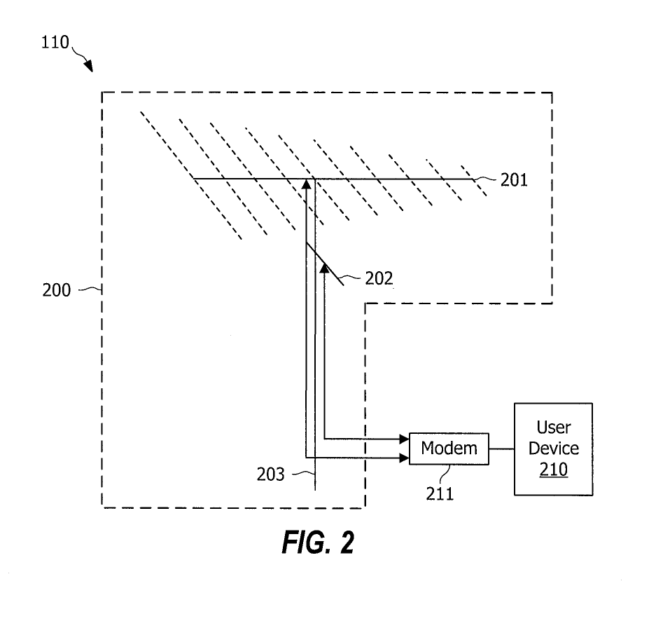

Receiving station 110 may comprise various configurations of a station adapted for receiving wireless signals via a SFN. Detail with respect to an embodiment of receiving station 110 adapted according to concepts herein is shown in FIG. 2. Receiving station 110 of the embodiment illustrated in FIG. 2 comprises user device 210 coupled to antenna system 200 for providing wireless communications, wherein antenna system 200 provides an augmented antenna system in accordance with concepts herein. Antenna system 200 may, for example, comprise a rooftop antenna configuration. Antenna system 200 of the illustrated embodiment comprises primary antenna 201, such as may comprise a directional antenna (e.g., Yagi aerial, phased array antenna, etc.), coupled to user device 210 through modem 211. Primary antenna 201 may comprise an antenna conforming to the ITU-R BT419-3 guidelines according to embodiments herein. User device 210 may, for example, comprise one or more terminal devices, such as a television, a computing device (e.g., personal computer (PC), notebook computer, tablet device, etc.), a personal digital assistant (PDA), a smartphone, an internet appliance, and/or the like. It should be appreciated that, although the embodiment illustrated in FIG. 2 shows modem 211 separate from user device 210, user device 210 of embodiments may comprise modem 211 therein.

Referring to FIGS. 1 and 2, primary antenna 201 of receiving station 110, being disposed in SFN 101 in the illustrated embodiment, is pointed in the direction of the best transmitting station in SFN 101, which in most cases will be the closest desired transmitter, which in the illustrated embodiment is transmitter station 120 disposed along the 0 degree axis. For example, the zero degree direction of primary antenna 201 is pointed to the transmitting station of SFN 101 with the lowest path loss and likely strongest signal. Receiving station 110 of the embodiment illustrated in FIG. 1 is, however, disposed on the edge of the two adjacent SFNs (i.e., SFN 101, being the desired SFN, and SFN 102, being the undesired or interfering SFN). This deployment is a worst case receive location with respect to interference, wherein the receiving station is located on the edge of the service area and abuts the service area of an interfering network. It should be appreciated that in a situation where multiple SFNs have a junction, embodiments herein may likewise be utilized to provide interference cancellation. The cancelation achievable in such scenarios may, on average, be reduced, but operation of an augmented antenna system according to the concepts herein is nevertheless functional.

SFN 101 and SFN 102 may, for example, provide a low tower, low power network configuration in which the same frequencies are utilized in each portion of the coverage areas (i.e., 100% spectral reuse). For example, each of SFN 101 and SFN 102 may comprise an evolved Multimedia Broadcast Multicast Service (eMBMS) utilized for efficient broadcast delivery of television signals within a particular area, such as an urban area. It should be appreciated that there should be sufficient isolation between adjacent SFNs to support the desired Signal to Interference plus Noise Ratio (SINR) if the receiving stations of system 100 are to provide satisfactory wireless communications. However, the front-to-back isolation provided by primary antenna 201 may insufficient to provide the requisite isolation, or insufficient to provide the requisite isolation in all situations (e.g., the edge receiving station deployment illustrated in FIG. 1). For example, the front-to-back ratio of antennas conforming to the ITU-R BT419-3 guidelines is approximately 16 dB. Such isolation may be insufficient to provide satisfactory reception, such as at edge locations of two adjacent SFNs.

Although only utilizing a single antenna port in a typical deployment of receiving stations for television signal broadcast networks, modem 211 may nevertheless comprise a plurality of antenna ports (or may be adapted to comprise a plurality of antenna ports). For example, all LTE compliant modems are required to support at least antenna two ports (see e.g., 3GPP TS 36.101 Technical Specification Group Radio Access Network; Evolved Universal Terrestrial Radio Access (E-UTRA); User Equipment (UE) radio transmission and reception). The two antenna ports of a LTE modem were designed for connection to two decorrelated antennas (e.g., orthogonally polarized antennas) in order to achieve maximum benefit due to path diversity reception often present in mobile communications. Such a multiple antenna port modem configuration may implement a function to combine the signals of each antenna port to provide desired channel receive gain. Combining the signals provided by decorrelated antennas of embodiments herein by the receivers of a multiport modem (or other multiple receiver circuit) facilitates implementation of many possible functions for providing interference mitigation in accordance with the concepts herein, such as a Minimum Mean Square Error (MMSE) function or a Maximum Ratio Combining (MRC) function. For example, in a typical non-line of sight (i.e. multipath rich) environment, the signals from the two respective ports may be combined via the well-known method of MMSE to result in the incident signal on the two decorrelated antennas being combined to maximize the SINR on a per OFDM carrier basis.

In contrast to the foregoing scenario, a typical roof top television antenna has a single horizontally polarized output, which aligns with the horizontal polarization aligned transmit antenna. Due to the line of site, or near line of site, propagation to a roof top antenna, there is little possible gain from using a second antenna port, such as for capturing vertically polarized signals. Although a second large roof top antenna (e.g., a second instance of primary antenna 201) could be used to gather more signal, if the vertical distance between the two antennas is sufficient, such a configuration is typically unsatisfactory for deployment in the typical use case scenarios. For example, such a second instance of the primary antenna results in an appreciably more expensive and complicated antenna system, in addition to presenting a potentially unsightly and unacceptably large configuration.

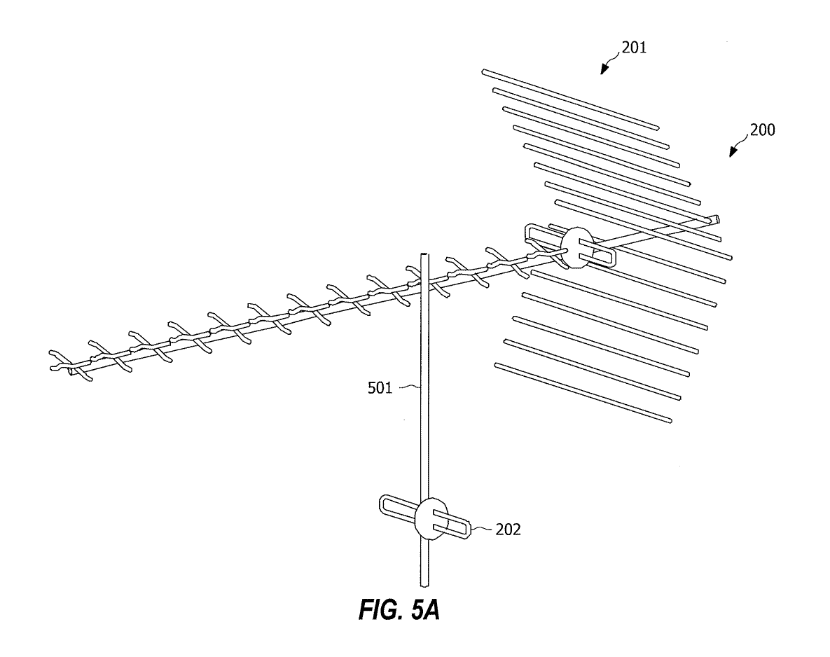

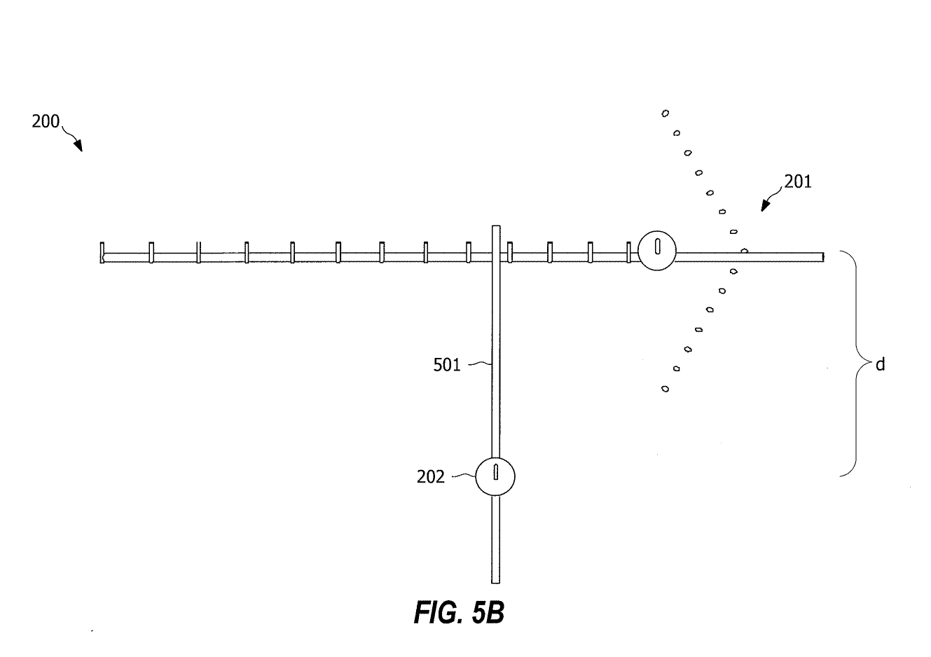

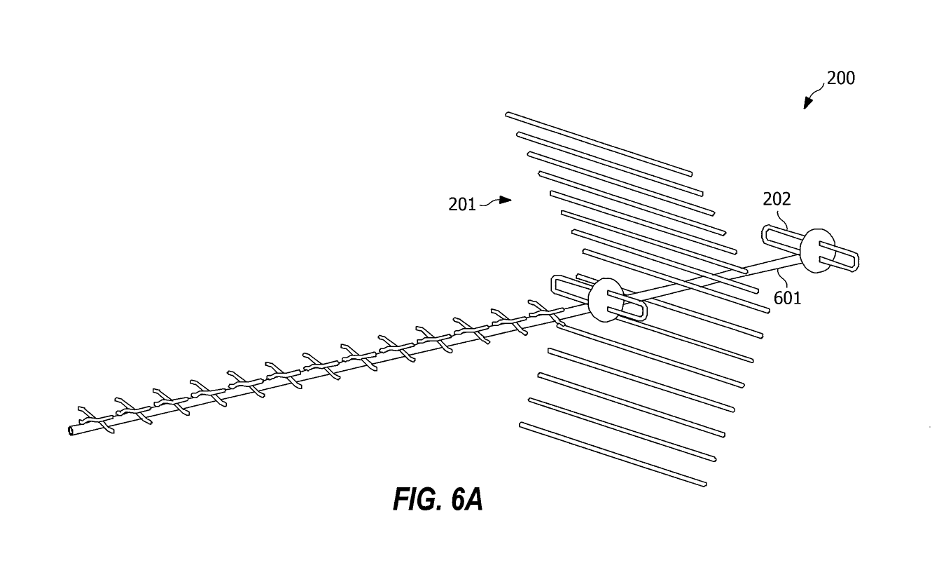

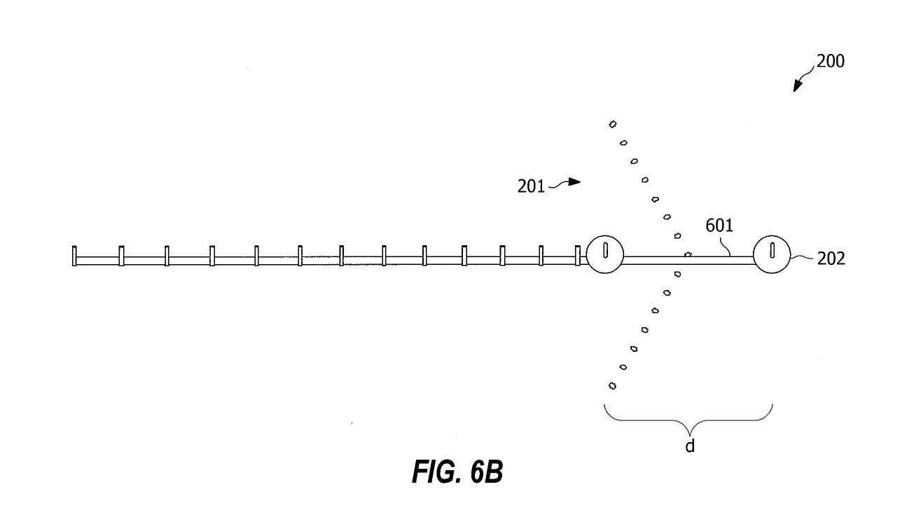

Embodiments herein implement configurations which benefit from utilizing a plurality of antenna ports by enhancing the performance of the receiver station with respect to interference rejection. For example, the second antenna port of a LTE modem may be utilized with respect to a secondary antenna element according to embodiments. Such embodiments may, for example, utilize an otherwise unused antenna port of a LTE receiver of an eMBMS network. The secondary antenna element utilized according to embodiments is correlated with the primary antenna (i.e., not orthogonal therewith), such as to provide a same polarization (e.g., horizontal polarization in the foregoing example). Moreover, the secondary antenna element utilized according to embodiments is heterogeneous with respect to the primary antenna (i.e., an antenna element having a substantially different configuration), such as to provide an omnidirectional antenna configuration in contrast to the directional configuration of the primary antenna, to provide a simple antenna element structure in contrast to the reflector, director, and/or antenna element array configuration of the primary antenna, and/or to provide a substantially smaller antenna element than the primary antenna (e.g., a secondary antenna element that is 1/10, or less, than the physical size of the primary antenna). In particular, embodiments of the secondary antenna are sized to as to achieve a positive C/N for the undesired or interfering signals. For example, the illustrative embodiments of FIGS. 5A, 5B, 6A, and 6B discussed below provide a configuration in which the primary antenna is comprised of 14 elements plus a back reflector, whereas the secondary antenna comprises 1 element, and is therefore approximately less than 1/14 of the primary antenna length dimension. The use of such a substantially smaller secondary antenna in embodiments of an augmented antenna system according to embodiments provides advantages, such as to minimize additional wind loading on the antenna mast structure and/or borne weight associated with the addition of the secondary antenna.

Antenna system 200 of FIG. 2 illustrates an embodiment of a secondary antenna element configuration, wherein secondary antenna element 202 comprises a correlated heterogeneous secondary antenna element. Secondary antenna element 202 may, for example, comprise a single monopole antenna, dipole antenna, loop antenna, folded dipole antenna, or bowtie antenna, or other simple antenna providing very similar reception performance in both the front and back planes (e.g., front-to-back isolation of approximately 0 dB). In contrast, primary antenna 201 may, for example, comprise a Yagi areal, a log-periodic array, a phased array, or other antenna providing directional reception. Thus, secondary antenna element 202 of embodiments provides a heterogeneous configuration with respect to primary antenna 201 (e.g., in antenna pattern directivity, in antenna structure, and in physical size). Despite such a heterogeneous configuration, secondary antenna element 202 of embodiments is deployed in a correlated configuration with respect to primary antenna 201 (e.g., in a correlated polarization, such as sharing the same horizontal polarization in the illustrated embodiment). Modem 211, such as may comprise a LTE modem, of the embodiment illustrated in FIG. 2 comprises a plurality of antenna ports whereby signals of both primary antenna 201 and secondary antenna element 202 may be combined by modem 211, such as using MMSE or MRC techniques.

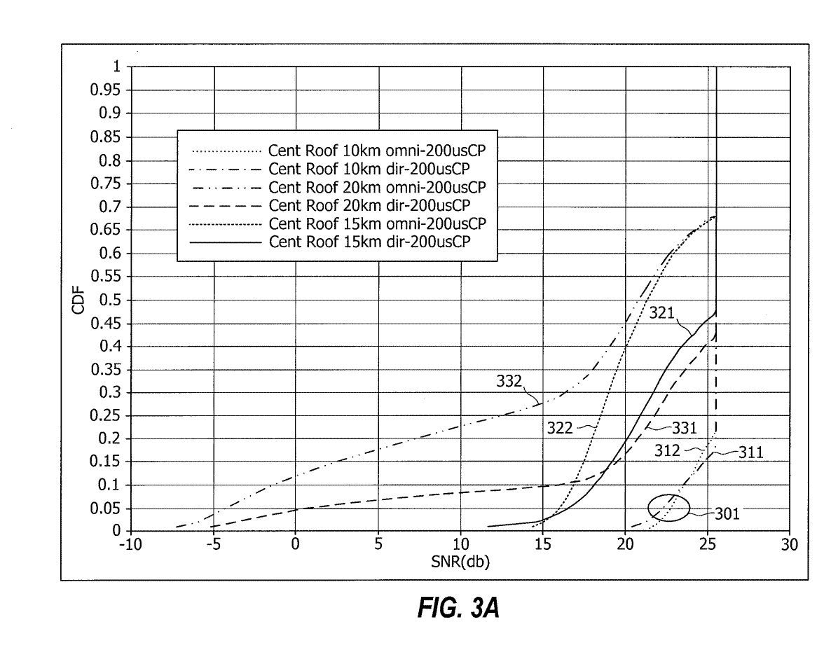

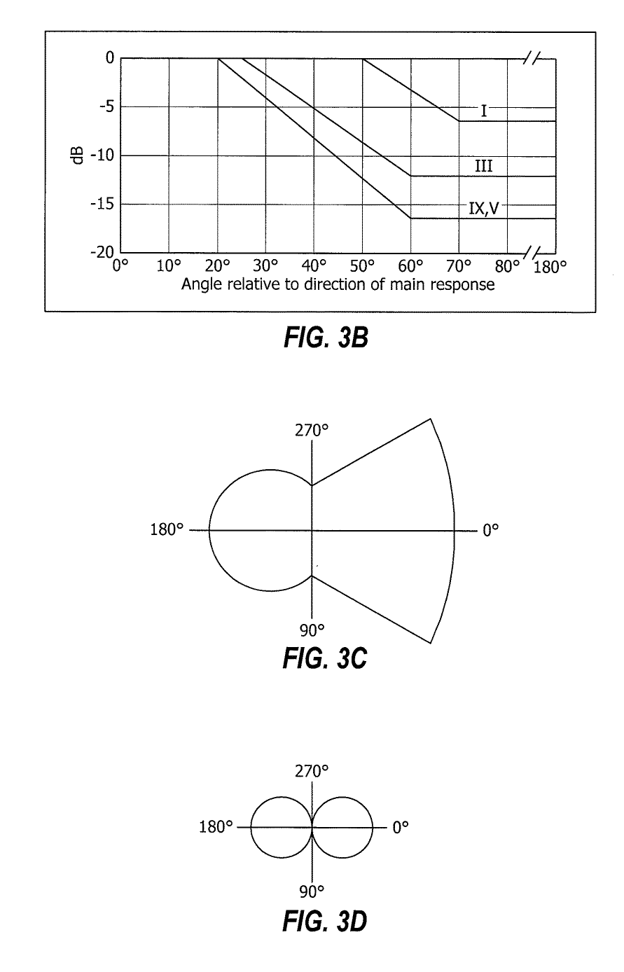

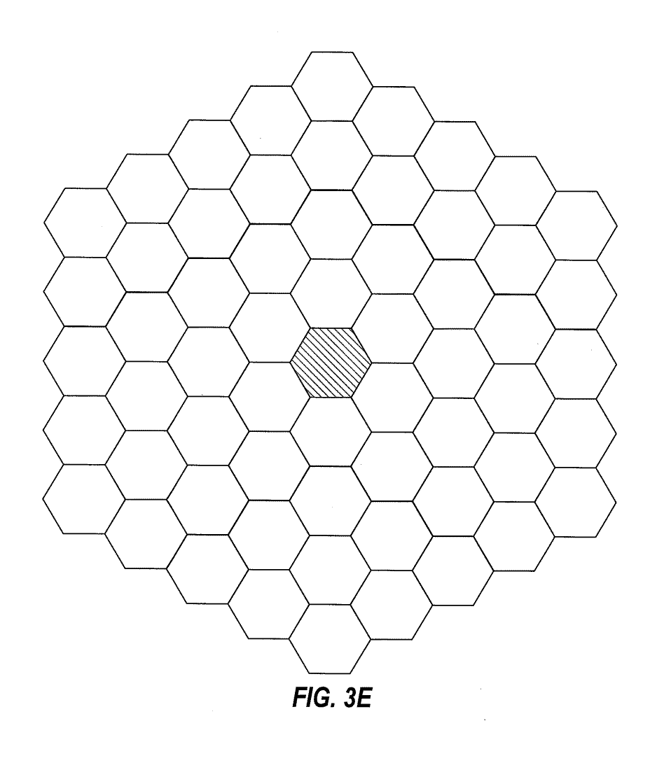

The simulation results of FIG. 3A are helpful in understanding operation to enhance the performance of receiver stations with respect to interference rejection using a correlated heterogeneous secondary antenna element according to embodiments herein. The table below shows the parameters utilized in generating the simulations of FIG. 3A. It should be appreciated, however, that the parameters of the table below are merely exemplary and are not constraining with respect to the generality of the concepts herein.

| | Rural |
|---|---|
| Frequency (MHz) | 540 |
| Antenna Height (m) | 30 |
| Slope (dB/decade) | 35.2 |
| Loss at 1 km | 94.1 |
| Average EIRP (dBW) in 5 MHz | 33 |
| Implied Loss (dB) | 3 |
| Standard Deviation of Log Normal | 6 |
| Shadowing | |
| Downtilt (deg) | 1 |
| Noise Figure (dB) | 7 |
| Receive Height (m) | 10 |
| Vertical Beam Width (deg) | 10 |

FIG. 3A shows simulation results for two configurations of antennas in a plurality of use cases. In particular, one of the receive antennas simulated (graphs 311, 321, and 331) is an antenna with a pattern that corresponds to ITU-R BT 419, which is a common model for roof top reception used for television planning, such as may correspond to an embodiment of primary antenna 201 of embodiments. The gain of this antenna is set to 10 dBd (it being appreciated that embodiments herein may utilize primary antennas providing other levels of gain). The discrimination provided by an exemplary embodiment of such a directional antenna is shown in FIG. 3B, wherein the number of the particular broadcasting band is shown by each corresponding graph. The other of the receive antennas simulated (graphs 312, 322, and 332) is an antenna with an omni-directional pattern having a 0 dBd gain (it being appreciated that embodiments herein may utilize secondary antennas providing other levels of gain), such as may correspond to an embodiment of secondary antenna element 202. The gain provided by a secondary antenna utilized according to embodiments of the invention may, for example, be selected so as to result in a signal provided by the secondary antenna having a positive C/N ratio for a dominant interfering signal.

Highly simplified representations of the antenna patterns in the azimuthal plane for each of the antennas are shown in FIGS. 3C and 3D, wherein FIG. 3C shows a representative antenna pattern for the simulated directional antenna and FIG. 3D shows a representative antenna pattern for the simulated omni-directional antenna. The simulations of FIG. 3A include the use cases of 10 km radius (graphs 311 and 312), 15 km radius (graphs 321 and 322), and 20 km radius (graphs 331 and 332) cells in a 61 site SFN. FIG. 3E shows a representation of such a 61 site SFN, wherein it is assumed that a omni-directional broadcast transmitter is disposed in the center of each hexagon, and wherein the radius of each hexagon is approximately 10 km.

It can be observed in FIG. 3A that the achieved Signal to Interference plus Noise Ratio (SINR) for the 10 km radius (graphs 311 and 312) for both antenna configurations (i.e., the 0 dBd gain (omni) antenna (graph 312) and the 10 dBd gain (directional) antenna (graph 311)) is approximately 23 dB at 95% coverage, and the achieved SINR is within 1 dB for the two antenna gains. This demonstrates that the network is not noise limited for either antenna. In the case where the simulated SFN comprises an eMBMS transmission system, the actual SINR may be limited by the extra Cyclic Prefix (CP) energy (e.g., the maximum path length difference for the simulation of 233 usec, while the assumed CP is 200 usec). This results in the most distant ring of sites in FIG. 3E (i.e., the cells disposed at the periphery of the 61 cell cluster) interfering in the center hexagonal area for which the simulated reception is calculated.

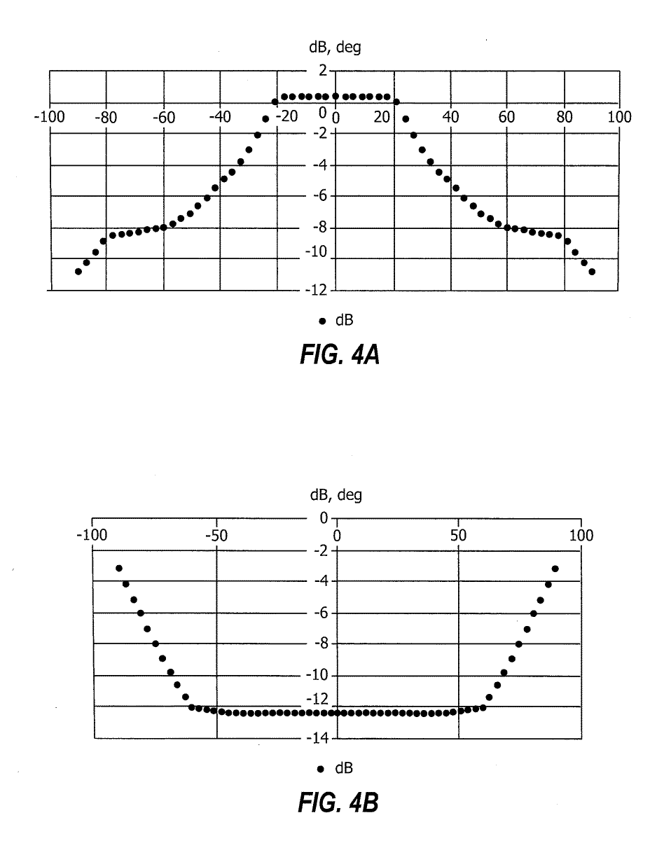

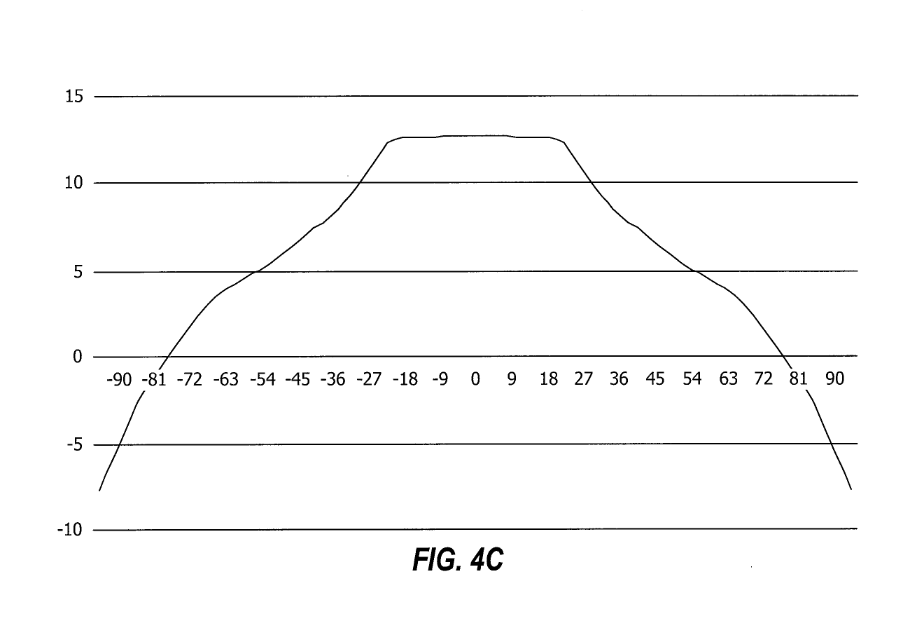

The total power received by the directional antenna in the illustrative 61 cell SFN network may be calculated based on constant power from each transmit site as a function of pointing direction of the directional antenna. The total received power is represented in FIG. 4A, wherein the receive signal level as a function of antenna direction is shown (the 0 dB level being the level received from the best transmit site). As can be seen in the graph of FIG. 4A, the signal levels are far above the noise, which is consistent with the simulation results of FIG. 3A.

As represented in the illustrative antenna pattern of FIG. 3C, the directional antenna configuration includes a back-lobe aspect, wherein, despite the directivity of the antenna, signal reception from outside of the main antenna beam is experienced. FIG. 4B shows the relative power received from the rear interference SFN relative to the forward pointing direction of the antenna (e.g., 0 degrees in FIG. 4B correspond to the main lobe pointing in the same direction as 0 degrees in FIG. 4A).

FIG. 4C shows the net SINR for the directional antenna as a function of pointing direction, such as due to adjacent SFN co-channel interference of the undesired network. In particular, the net SINR of FIG. 4C is the difference between the total receive power of FIG. 4A and the interference level of FIG. 4B. Although it would be expected when pointing two antennas in the same direction in the same network, wherein one antenna provides higher gain (e.g., 10 dB) than the other, that the antenna with the higher gain would experience a higher SINR, the forgoing graphs do not reflect such a result. The foregoing results indicate that the SINR is not dominated by thermal noise, but is instead dominated by self-interference.

As shown by the simulations of FIG. 3A, the self-interference plus noise limit for a 61 site SFN is in the range of 200 (23 dB) for 10 km site radius, while the co-channel interference limited SINR for the adjacent undesired SFN is in the range of 20 (13 dB), as shown in FIG. 4C. In situations such as this, wherein the received signal is well above the thermal noise level, embodiments may utilize a low gain antenna (e.g., secondary antenna element 202) to receive both interference and desired signal at a positive C/N. It should be appreciated that a positive C/N, for both the desired and undesired signals, provides a desirable condition for the function of MMSE in the diversity reception receiver. In particular, operation of the Minimum Mean Square Error functionality can determine that the interference in the second port is correlated to the interference in the first port and operate to null that interference.

Referring again to FIG. 2, an exemplary configuration of a receiving station antenna system adapted to enhance receive signal isolation using relatively simple and inexpensive modifications or additional circuitry according to embodiments is shown. Primary antenna 201 may, for example, comprise a conventional and likely pre-existing television antenna connected to one port of modem 211, such as may comprise a LTE modem used in an eMBMS transmission system. Secondary antenna element 202 may comprise a low gain antenna connected to a second port of modem 211. The use of such a correlated heterogeneous secondary antenna according to embodiments herein provides, appreciable interference cancellation (e.g., on the order of 10 dB in the foregoing illustrative 10 km cell using an ITU-R BT 419 directional primary antenna and 0 dB gain bowtie omni-directional secondary antenna), utilizing the MMSE functionality and/or MRC functionality of the modem (e.g., a signal processing circuit of the modem providing MMSE and/or MRC operation) to cancel the strongest interfering signal on each carrier (the degree to which the interfering signal is cancelled corresponds to the ratio of the largest interferer to the second largest interferer, wherein in the exemplary SFNs the largest interferer is likely to be approximately 10 dB stronger than the second largest interferer, thus providing front-to-back isolation improvement of approximately 10 dB). For example, where the primary antenna comprises an ITU-R BT419-3 compliant antenna (i.e., itself providing front-to-back isolation of approximately 16 dB), the front-to-back isolation provided by the antenna system including the secondary antenna element of embodiments herein may provide front-to-back isolation of approximately 26 dB.

The table below illustrates, at a very high conceptual level, the concept of the technique by which MMSE combining of the signals provided to the two modem ports according to embodiments optimizes the high interference (e.g., interference limited) aspect of the received signals. It should be appreciated that the scalar example of the table below is merely exemplary and is not constraining with respect to the generality of the concepts herein. In the example of the table below, the primary antenna receives the desired signal (e.g., desired eMBMS carrier signal) at a power level of 20 while receiving the undesired signal (e.g., eMBMS carrier signal of an adjacent SFN) at a power level of 1 (e.g., due to the directivity of the primary antenna). Also in the example of the table below, the secondary antenna element receives the desired signal (e.g., the desired eMBMS carrier signal) at a power level of 1 while receiving the undesired signal (e.g., the eMBMS carrier signal of an adjacent SFN) also at a power level of 1 (e.g., due to the omni-directional configuration of the secondary antenna element). Operation of the MMSE functionality determines that the interference in the signal provided by the secondary antenna element is correlated to the interference in the signal provided by the primary antenna, and will essentially multiply the signal provided by the secondary antenna element by −1 and add that inverted signal to the signal provided by the primary antenna port to cancel the interference. It should be appreciated that in actual operation, the modem implementation of an eMBMS transmission system maximizes the SINR of each OFDM carrier independently, whereas the table below depicts the process as single scale and combine. The actual result is likely not complete cancelation, such as due to implementation details and the antenna pattern differences between the secondary antenna relative to the back lobes of the primary antenna. As the vector coefficients of the individual OFDM carriers are optimized individually, the dominate interference path having the largest interference term can be canceled on a per carrier basis. It should be appreciated that, in the foregoing operation, the actual coefficient selected actually maximize the SINR, on a per carrier basis, rather than completely eliminating the largest interference term. Nevertheless, appreciable interference cancellation is provided, such as to provide the aforementioned 10 dB improvement as compared to the front-to-back ratio provided through operation of the primary antenna alone.

| | | Desired Signal | Undesired Signal |
|---|---|---|---|
| Modem Port | Multiplier | Power | Power |
| Primary Antenna | 1 | 20 | 1 |
| Secondary Antenna | −1 | 1 | 1 |

| | | |
|---|---|---|
| Sum of signals from two | 19 | 0 |
| modem ports | | |

The benefit achieved through use of an augmented antenna configuration of embodiments is, among other, things impacted by the relative dominance of the worst aggressor or the strongest interfering signal. MMSE functionality operates to maximize the SINR achieved on a per OFDM carrier basis available via the vector combination of the signals available at the two ports according to embodiments. In a case for which the gains of the primary and secondary antennas is similar, there can be a gain in the desired signal level of up to 3 dB, for example. In such a case, the difference in gain between the primary and secondary antenna may result in the maximum desired signal gain being less than 0.5 dB. The level of cancelation achieved may be as high as 15 dB, for example, although the level of cancellation may be lower.

FIGS. 5A, 5B, 6A and 6B show several implementations of antenna system 200 adapted according to embodiments of the present disclosure. In particular, the configurations illustrated in each of FIGS. 5A and 5B and FIGS. 6A and 6B provide a receiving station antenna system adapted to enhance receive signal isolation using relatively simple and inexpensive modifications or additional circuitry according to the concepts herein. Secondary antenna element 202 of each of these illustrated configurations provides a correlated heterogeneous secondary antenna implementation. For example, secondary antenna element 202 of these illustrated embodiments is correlated with primary antenna 201, to thereby provide a non-orthogonal antenna element (i.e., providing a same polarization, shown here as horizontal polarization) with respect to primary antenna 201. Further, secondary antenna element 202 of these illustrated embodiments is heterogeneous with respect to primary antenna 201 (i.e., a simple, small dipole antenna element as compared to the more complex, considerably larger Yagi aerial of the primary antenna, whereby the secondary antenna element provides an omnidirectional antenna configuration in contrast to the directional configuration of the primary antenna). Although not shown in the illustrations of FIGS. 5A, 5B, 6A, and 6B, primary antenna 201 and secondary antenna element 202 thereof may be coupled to separate ports of MMSE functionality for signal processing to provide interference cancellation as described herein.

FIGS. 5A and 5B show a configuration of antenna system 200 in which primary antenna 201 comprises a Yagi aerial (e.g., a pre-existing TV antenna deployment as may be utilized for eMBMS transmission reception) and a relatively simple configuration (e.g., dipole antenna) for secondary antenna element 202, as may be retrofitted or otherwise added to antenna system 200, such as through fastening to antenna mast 501 (e.g., using a mast clip, “U” mounts, and/or other known antenna fastening techniques). It should be appreciated that although the embodiment of FIGS. 5A and 5B shows secondary antenna element 202 disposed below primary antenna 201, secondary antenna element 202 may be disposed in other locations relative to primary antenna 201 (e.g., above or behind primary antenna 201). However, the embodiment illustrated in FIGS. 5A and 5B provides a configuration which is readily adaptable to pre-existing antenna systems, such as by utilizing antenna mast 501 which typically extends below primary antenna 201.

FIGS. 6A and 6B show a configuration of antenna system 200 in which, although primary antenna 201 comprises a Yagi aerial and secondary antenna element comprises a simple configuration (e.g., dipole antenna) similar to FIGS. 5A and 5B, secondary antenna element 202 has been included in the structure of primary antenna 201 (e.g., disposed upon support member 601, which provides a support structure for the active antenna elements, directors, and reflectors of primary antenna 201 of the illustrated embodiment). As support member 601 may be unlikely to extend much beyond antenna components it is designed to support, the embodiment of FIGS. 6A and 6B represents a configuration which may be initially manufactured to include the primary and secondary antenna elements described herein. It should be appreciated that although the embodiment of FIGS. 6A and 6B shows secondary antenna element 202 disposed behind primary antenna 201, secondary antenna element 202 may be disposed in other locations relative to primary antenna 201 (e.g., above or below primary antenna 201). Although secondary antenna element 202 of the configuration of FIGS. 6A and 6B may be included in antenna system 200 at a time of manufacture, the exemplary configuration nevertheless provides a configuration in which the additional circuitry is relatively simple, inexpensive, and easily implemented.

The particular location at which secondary antenna element 202 is disposed relative to primary antenna 201 of embodiments may be selected so as to minimize interaction of the two antennas. Embodiments may, for example, utilize a spacing between the primary and secondary antenna elements (i.e., distance d shown in FIGS. 5B and 6B) of approximately λ/2 at the mid-band for the antenna system (i.e., d≧λ/2, according to embodiments). For example, in an eMBMS implementation, λ/2≈27 cm, and thus d≧27 cm. Embodiments which utilize a spacing between the primary and secondary antenna elements of less than λ/2 at the mid-band for the antenna system (i.e., d≦λ/4) may result in interaction between the primary and secondary antenna elements such that antenna pattern beam tilt (e.g., downtilt) is experienced, or increased, as compared to embodiments utilizing greater antenna element spacing (e.g., λ/2).

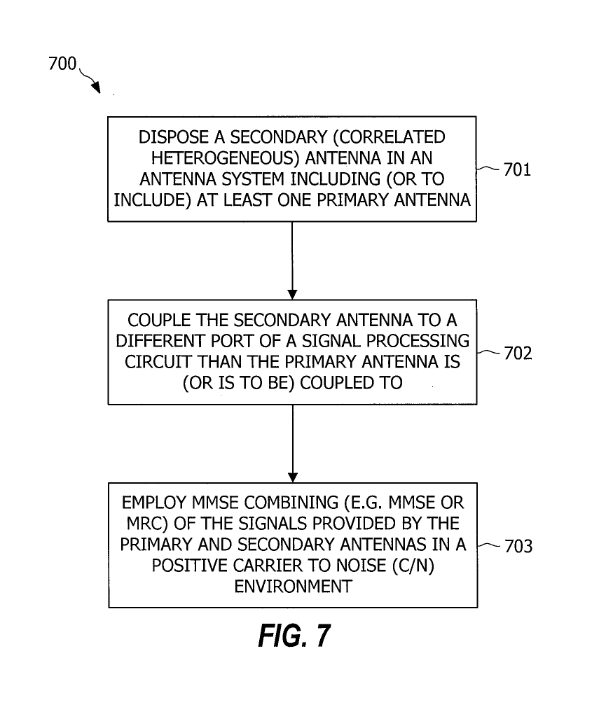

FIG. 7 shows a high level flow diagram of a method for providing increased receive signal front-to-back isolation in a wireless communication system in accordance with the foregoing. Flow 700 of the illustrated embodiment of FIG. 7 includes, at block 701, disposing a secondary antenna in an antenna system, the antenna system including a primary antenna, wherein the secondary antenna is correlated and heterogeneous with respect to the primary antenna. At block 702, the secondary antenna is coupled to a different port of a signal processing circuit (e.g., MMSE signal processing circuit or MRC signal processing circuit) than is the primary antenna. Thereafter, at block 703, combining of the signals (e.g, using MMSE or MRC combining) provided by the primary and secondary antennas may be employed, such as in a positive C/N environment, to provide an appreciable increase (as compared to operation of the primary antenna alone) in front-to-back isolation with respect to desired signals received at a receiving station utilizing the resulting antenna system.

From the foregoing, it can be appreciated that embodiments herein provide a relatively simple means by which additional interference rejection may be achieved using one or more small omni-antenna(s), in addition to a directional antenna (e.g., typical existing off air roof top television antenna), attached to otherwise potentially unutilized second input port(s) of a MMSE and/or MRC capable modem. Such a small omni-antenna may, for example, comprise a broadband dipole structure or other simple antenna configuration. Similarly, embodiments may enhance performance by means of one or more additional small omni-antenna(s) added to new directional antenna that is part of an integrated assembly. Such an embodiment is well suited to new installations, whereas embodiments adding the aforementioned small omni antenna to an antenna system may be well suited to pre-existing antenna system installations. Such embodiments provide a relatively simple to implement technique to enhance the interference isolation for a system with diversity reception system, such as LTE (e.g., an eMBMS use case where the network is interference limited potentially due to co-channel interference from possibly an adjacent SFN). Irrespective of the particular implementation, embodiments introduce a small, simple antenna element (e.g., a 0 dB monopole, dipole, loop, folded dipole, or bowtie antenna), coupled to an otherwise unused MMSE or MRC receiver port, to improve the front-to-back ratio of a directional antenna system. It should be appreciated that such a technique may be applied to various wireless network configurations, such as a high tower high power signal incident on a low power low tower network. A low tower, low power network utilizing antenna systems adapted according to the concepts herein, particular with respect to receiving stations disposed at the edges of SFNs, may operate with 100% spectral reuse due to the antenna system providing sufficient isolation. The MMSE or MRC modem utilized according to embodiments essentially operates to place a steered null on the primary source of interference on a per OFDM carrier basis, although the actual result is optimized SINR on a per carrier basis. However, the performance of a system on a single source of interference (i.e., not SFN) will likely be significantly better than for SFN interference, as the MMSE or MRC receiver will be more effective in this situation.

It should be appreciated that the concepts herein are not limited to application with respect to the eMBMS transmission systems of exemplary embodiments described herein. For example, embodiments may be utilized in various networks in which receiving stations are interference limited or are otherwise experiencing high interference and/or may be utilized with respect to various configurations of receiving stations implementing MMSE and/or MRC functionality.

While the embodiments described herein have been described with reference to numerous specific details, one of ordinary skill in the art will recognize that the embodiments can be embodied in other specific forms without departing from the spirit of the embodiments. Thus, one of ordinary skill in the art would understand that the embodiments described herein are not to be limited by the foregoing illustrative details, but rather are to be defined by the appended claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A method for increased receive signal front-to-back isolation in a wireless communication system, the method comprising:
disposing a secondary antenna element in an antenna system to thereby provide an augmented antenna system, the antenna system including a primary antenna, wherein the secondary antenna element is a correlated heterogeneous antenna element with respect to the primary antenna;
coupling the secondary antenna element to a port of a signal processing circuit having at least one of a Minimum Mean Square Error (MMSE) processing circuit or a Maximum Ratio Combining (MRC) processing circuit, wherein the primary antenna is coupled to a different port of the signal processing circuit; and
employing MMSE or MRC combining of a signal provided by the primary antenna and a signal provided by the secondary antenna element by the signal processing circuit to provide interference cancellation for interference present in the signal provided by the primary antenna.

2. The method of claim 1, wherein the signal provided by the primary antenna and the signal provided by the secondary antenna element each have a positive carrier to noise (C/N) ratio.

3. The method of claim 1, wherein the signal provided by the secondary antenna element has a positive carrier to noise (C/N) ratio for a dominant interfering signal.

4. The method of claim 1, wherein the heterogeneity of the secondary antenna element comprises at least one of a substantial gain difference between a gain provided by the secondary antenna element and a gain provided by the primary antenna or a directivity difference between a directivity provided by the primary antenna and a directivity provided by the secondary antenna element.

5. The method of claim 4, wherein the primary antenna comprises one of a directional antenna or a Yagi aerial, and wherein the secondary antenna element comprises one of an omni-directional antenna, a single monopole antenna, a single dipole antenna, a single loop antenna, a single folded dipole antenna, or a single bowtie antenna.

6. The method of claim 1, wherein the heterogeneity of the secondary antenna element comprises a size difference between a physical size of the primary antenna and a physical size of the secondary antenna element, wherein the secondary antenna element comprises an antenna having a physical size selected to achieve a positive carrier to noise (C/N) with respect to interfering signals for which cancellation is performed.

7. The method of claim 1, wherein the correlation of the secondary antenna element to the primary antenna comprises a same polarization.

8. The method of claim 1, wherein the wireless communication system comprises a single frequency network (SFN) communication system having a plurality of SFNs therein, wherein the augmented antenna system is deployed at an edge of a first SFN of the plurality of SFNs, and wherein the edge of the first SFN is adjacent to another SFN of the wireless communication system.

9. The method of claim 1, wherein the antenna system comprises a pre-existing antenna system onto which the secondary antenna system is added by the disposing the secondary antenna element in the antenna system.

10. The method of claim 1, wherein the disposing the secondary antenna element in the antenna system comprises:
disposing the secondary antenna element at least λ/2, at a mid-band for the antenna system, distance from an active element of the primary antenna.

11. The method of claim 10, wherein the disposing the secondary antenna element in the antenna system comprises:
disposing the secondary antenna element behind the primary antenna, wherein behind is determined by a direction opposite a main antenna pattern beam of the primary antenna.

12. The method of claim 1, wherein the signal processing circuit comprises a multiport modem having two or more ports provided for connection to two decorrelated antennas, wherein the port to which the secondary antenna element is coupled and the different port to which the primary antenna element is coupled are ports of the two or more ports.

13. A system for increased receive signal front-to-back isolation in a wireless communication system, the system comprising:
an antenna system having a primary antenna and a secondary antenna element, wherein the secondary antenna element is a correlated heterogeneous antenna element with respect to the primary antenna, and wherein the secondary antenna element is disposed in the antenna system to provide an augmented antenna system; and
a signal processing circuit having a plurality of signal input ports and having at least one of a Minimum Mean Square Error (MMSE) processing circuit or a Maximum Ratio Combining (MRC) processing circuit, wherein the first antenna element is coupled to a first port of the plurality of signal input ports and the secondary antenna element is coupled to a second port of the plurality of signal input ports, and wherein the signal processing circuit is operable to combine a signal provided by the primary antenna and a signal provided by the secondary antenna element using MMSE or MRC combining to provide interference cancellation for interference present in the signal provided by the primary antenna.

14. The system of claim 13, wherein the signal provided by the primary antenna and the signal provided by the secondary antenna element each have a positive carrier to noise (C/N) ratio.

15. The system of claim 13, wherein the signal provided by the secondary antenna element has a positive carrier to noise (C/N) ratio for a dominant interfering signal.

16. The system of claim 13, wherein the heterogeneity of the secondary antenna element comprises at least one of a substantial gain difference between a gain provided by the secondary antenna element and a gain provided by the primary antenna or a directivity difference between a directivity provided by the primary antenna and a directivity provided by the secondary antenna element.

17. The system of claim 16, wherein the primary antenna comprises one of a directional antenna or a Yagi aerial, and wherein the secondary antenna element comprises one of an omni-directional antenna, a single monopole antenna, a single dipole antenna, a single loop antenna, a single folded dipole antenna, or a single bowtie antenna.

18. The system of claim 13, wherein the heterogeneity of the secondary antenna element comprises a size difference between a physical size of the primary antenna and a physical size of the secondary antenna element, wherein the secondary antenna element comprises an antenna having a physical size selected to achieve a positive carrier to noise (C/N) with respect to interfering signals for which cancellation is performed.

19. The system of claim 13, wherein the correlation of the secondary antenna element to the primary antenna comprises a same polarization.

20. The system of claim 13, wherein the wireless communication system comprises a single frequency network (SFN) communication system having a plurality of SFNs therein, wherein the augmented antenna system is deployed at an edge of a first SFN of the plurality of SFNs, and wherein the edge of the first SFN is adjacent to another SFN of the wireless communication system.

21. The system of claim 13, wherein the antenna system comprises a pre-existing antenna system onto which the secondary antenna system is added by the disposing the secondary antenna element in the antenna system.

22. The system of claim 13, wherein the secondary antenna element is disposed at least λ/2, at a mid-band for the antenna system, distance from an active element of the primary antenna.

23. The system of claim 22, wherein the secondary antenna element is disposed behind the primary antenna, wherein behind is determined by a direction opposite a main antenna pattern beam of the primary antenna.

24. The system of claim 13, wherein the signal processing circuit comprises a multiport modem having two or more ports provided for connection to two decorrelated antennas, wherein the port to which the secondary antenna element is coupled and the different port to which the primary antenna element is coupled are ports of the two or more ports.

25. A system for increased receive signal front-to-back isolation in a wireless communication system, the system comprising:
means for disposing a secondary antenna element in an antenna system to thereby provide an augmented antenna system, the antenna system including a primary antenna, wherein the secondary antenna element is a correlated heterogeneous antenna element with respect to the primary antenna;
means for coupling the secondary antenna element to a port of a signal processing circuit having at least one of a Minimum Mean Square Error (MMSE) processing circuit or a Maximum Ratio Combining (MRC) processing circuit, wherein the primary antenna is coupled to a different port of the signal processing circuit; and
means for employing MMSE or MRC combining of a signal provided by the primary antenna and a signal provided by the secondary antenna element by the signal processing circuit to provide interference cancellation for interference present in the signal provided by the primary antenna.

26. The system of claim 25, wherein the correlation of the secondary antenna element to the primary antenna comprises a same polarization, and wherein the heterogeneity of the secondary antenna element comprises at least one of a substantial gain difference between a gain provided by the secondary antenna element and a gain provided by the primary antenna or a directivity provided by the primary antenna and a directivity provided by the secondary antenna element.

27. The system of claim 25, wherein the correlation of the secondary antenna element to the primary antenna comprises a same polarization, and wherein the heterogeneity of the secondary antenna element further comprises a size difference between a physical size of the primary antenna and a physical size of the secondary antenna element, wherein the secondary antenna element comprises an antenna having a physical size selected to achieve a positive carrier to noise (C/N) with respect to interfering signals for which cancellation is performed.

28. The system of claim 25, wherein the antenna system comprises a pre-existing antenna system onto which the secondary antenna system is added by the disposing the secondary antenna element in the antenna system.

29. The system of claim 25, wherein the secondary antenna element is disposed at least λ/2, at the mid-band for the antenna system, distance from an active element of the primary antenna.

30. The system of claim 29, wherein the secondary antenna element is disposed behind the primary antenna, wherein behind is determined by a direction opposite a main antenna pattern beam of the primary antenna.
